(19) United States
(12) Patent Application Publication
(10) Pub. No.: US 2025/0312898 A1
(43) Pub. Date: Oct. 9, 2025

(54) POWER TOOL INCLUDING DEPTH SENSING

(71) Applicant: MILWAUKEE ELECTRIC TOOL CORPORATION, Brookfield, WI (US)

(72) Inventors: Carter H. Ypma, Milwaukee, WI (US); Arvind Balaji Narayan, Milwaukee, WI (US); Jasmine A. Priatna, Chicago, IL (US); Jonathan M. Fritsch, Lemont, IL (US)

(21) Appl. No.: 19/097,099

(22) Filed: Apr. 1, 2025

Related U.S. Application Data
(60) Provisional application No. 63/574,344, filed on Apr. 4, 2024.

(51) Int. Cl. B25B 23/00; B25B 21/02; B25B 23/18; H02P 6/20

(52) U.S. Cl. CPC B25B 23/0064; B25B 21/02; B25B 23/18; H02P 6/20

(57) ABSTRACT

A power tool includes a housing, a motor, and an actuator configured to be actuated by a user to cause the motor to operate. The power tool includes a depth sensor located adjacent to the output drive device and configured to generate a distance signal. The power tool includes an electronic controller coupled to the actuator and to the depth sensor. The electronic controller determines a first distance between the depth sensor and the workpiece by monitoring the distance signal from the depth sensor during operation of the motor. The electronic controller determines that the first distance has decreased to be less than or equal to the predetermined threshold distance. The electronic controller changes how the motor is controlled to operate in response to determining that the first distance has decreased to be less than or equal to the predetermined threshold distance.

### RELATED APPLICATIONS

This application claims the benefit of U.S. Provisional Patent Application No. 63/574,344, filed on Apr. 4, 2024, the entire content of which is hereby incorporated by reference.

### FIELD

The present disclosure relates to power tools.

### SUMMARY

The present disclosure relates to power tools that include one or more depth sensors to determine one or more distances between a power tool and a workpiece. The present disclosure also relates to techniques for controlling power tools with such depth sensors.

In some instances, power tools described herein include a housing and a motor within the housing. The motor may include a rotor and a stator. The rotor may be coupled to a motor shaft to produce a rotational output. The power tool may also include an output drive device configured to be driven by the motor shaft to perform a task. The power tool may also include an actuator configured to be actuated by a user to cause the motor to operate. The power tool may also include a depth sensor located adjacent to the output drive device and configured to generate a distance signal. The power tool may also include an electronic controller including an electronic processor and a memory. The electronic controller may be coupled to the actuator and to the depth sensor. The electronic controller may be configured to control the motor to operate in response to determining that the actuator has been actuated. The electronic controller may also be configured to determine a first distance between the depth sensor and the workpiece by monitoring the distance signal from the depth sensor during operation of the motor. The first distance may be greater than a predetermined threshold distance upon the actuator being actuated. The electronic controller may also be configured to determine that the first distance has decreased to be less than or equal to the predetermined threshold distance. The electronic controller may also be configured to change how the motor is controlled to operate in response to determining that the first distance has decreased to be less than or equal to the predetermined threshold distance.

In addition to any combination of features described above, the predetermined threshold distance may indicate a desired fastening depth. In addition to any combination of features described above, the electronic controller may be configured to change how the motor is controlled to operate in response to determining that the first distance has decreased to be less than or equal to the predetermined threshold distance by stopping the motor.

In addition to any combination of features described above, the predetermined threshold distance may indicate a second distance away from a desired fastening depth. In addition to any combination of features described above, the electronic controller may be configured to change how the motor is controlled to operate in response to determining that the first distance has decreased to be less than or equal to the predetermined threshold distance by slowing a speed of the motor from a first speed to a second speed.

In addition to any combination of features described above, the electronic controller may be configured to determine the predetermined threshold distance by monitoring the distance signal from the depth sensor during driving of a previous fastener into the workpiece by determining a second distance between the depth sensor and the workpiece in response to the motor being deactivated upon completion of a fastening operation of the previous fastener, and setting the predetermined threshold distance based on the second distance.

In addition to any combination of features described above, the electronic controller may be configured to determine the predetermined threshold distance by determining a second distance between the depth sensor and the workpiece prior to the motor being activated and in response to a user input that indicates the power tool is located in a position to measure a desired fastening depth. In addition to any combination of features described above, the electronic controller may be configured to set the predetermined threshold distance based on the second distance.

In addition to any combination of features described above, the electronic controller may be configured to determine an initial distance between the depth sensor and the workpiece at a time that the actuator is actuated and in response to determining that the actuator has been actuated. In addition to any combination of features described above, the electronic controller may be configured to determine the predetermined threshold distance by subtracting a predetermined value from the initial distance. In addition to any combination of features described above, the electronic controller may be configured to change how the motor is controlled to operate in response to determining that the first distance has decreased to be less than or equal to the predetermined threshold distance by increasing a speed of the motor from a starting speed to a driving speed.

In addition to any combination of features described above, the predetermined threshold distance may indicate a specified depth change from an initial depth. In addition to any combination of features described above, the electronic controller may be configured to operate the motor in a pulsed manner. The electronic controller may be configured to operate the motor in the pulsed manner by disabling the motor for a predetermined period of time in response to determining that the first distance has decreased the specified depth change from the initial depth to a second depth. The electronic controller may be configured to operate the motor in the pulsed manner by determining that the actuator has remained actuated during the predetermined period of time, in response to determining that the predetermined period of time has elapsed and that the actuator has remained actuated during the predetermined period of time. The electronic controller may be configured to operate the motor in the pulsed manner by re-enabling the motor until the first distance has again decreased the specified depth change from the second depth. The electronic controller may be configured to operate the motor in the pulsed manner by disabling the motor for the predetermined period of time in response to determining that the first distance has again decreased the specified depth change from the second depth. The electronic controller may be configured to operate the motor in the pulsed manner by continuing, until the first distance reaches a desired fastening depth or until the actuator is released, operating the motor in the pulsed manner by disabling the motor for the predetermined period of time and enabling the motor after the predetermined period of time and until the first distance has again decreased the specified depth change from a depth measured during the predetermined period of time of a directly preceding instance of the motor being disabled.

In addition to any combination of features described above, power tools may include a lighting element configured to illuminate a work area of the power tool. In addition to any combination of features described above, power tools may include a circuit board located adjacent to the output drive device. In addition to any combination of features described above, the circuit board may include the lighting element and the depth sensor.

In addition to any combination of features described above, the circuit board may include a ring-like-shaped circuit board that surrounds over half of an output axis of the output drive device.

In addition to any combination of features described above, power tools may include a hammer case held by the housing. In addition to any combination of features described above, power tools may include a nose piece that covers a front portion of the hammer case. In addition to any combination of features described above, the circuit board may be mounted on an inside of a front surface of the nose piece. In addition to any combination of features described above, the nose piece may include a lens to allow light from the lighting element to be emitted through the nose piece to illuminate the work area.

In addition to any combination of features described above, the nose piece may be mounted to the hammer case by being snap fit to a retention ring that is located in a groove on an outer peripheral surface of a forwardly protruding portion of the hammer case. In addition to any combination of features described above, the nose piece may include a rearwardly extending arm that is located between protrusions on the outer peripheral surface of the hammer case to prevent the nose piece from rotating around an output axis of the output drive device.

In some instances, power tools described herein include a housing, and a motor within the housing. The motor may include a rotor and a stator. The rotor may be coupled to a motor shaft to produce a rotational output. The power tool may also include an output drive device configured to be driven by the motor shaft to perform a task. The power tool may also include an actuator configured to be actuated by a user to cause the motor to operate. The power tool may also include a depth sensor located adjacent to the output drive device and configured to generate a distance signal. The power tool may also include an electronic controller including an electronic processor and a memory. The electronic controller may be coupled to the actuator and to the depth sensor. The electronic controller may be configured to control the motor to operate in response to determining that the actuator has been actuated. The electronic controller may also be configured to determine a first distance between the depth sensor and the workpiece by monitoring the distance signal from the depth sensor during operation of the motor at a first time. The electronic controller may also be configured to determine a second distance between the depth sensor and the workpiece by monitoring the distance signal from the depth sensor during operation of the motor at a second time. The electronic controller may also be configured to determine a feed rate of the power tool based on (i) a first difference between the first distance and the second distance and (ii) a second difference between the first time and the second time.

In addition to any combination of features described above, the electronic controller may be configured to control a speed of the motor based on the feed rate to maintain the feed rate within a range of a predetermined feed rate values.

In addition to any combination of features described above, the electronic controller may be configured to determine a speed of the motor by monitoring a position signal from a position sensor associated with the motor. In addition to any combination of features described above, the electronic controller may be configured to determine an output speed of the output drive device based on the speed of the motor. In addition to any combination of features described above, the electronic controller may be configured to determine a fastener pitch of a fastener being fastened by the power tool based on the feed rate and the output speed.

In addition to any combination of features described above, the electronic controller may be configured to control, based on the fastener pitch, the feed rate to be maintained within a range of a predetermined feed rate values.

In addition to any combination of features described above, the electronic controller may be configured to determine a speed of the motor by monitoring a position signal from a position sensor associated with the motor. In addition to any combination of features described above, the electronic controller may be configured to determine that the speed of the motor has increased a first predetermined amount. In addition to any combination of features described above, the electronic controller may be configured to determine that the feed rate has decreased a second predetermined amount. In addition to any combination of features described above, the electronic controller may be configured to change how the motor is controlled to operate by stopping the motor or by slowing a speed of the motor from a first speed to a second speed in response to determining (i) that the speed of the motor has increased the first predetermined amount and (ii) that the feed rate has decreased the second predetermined amount.

In some instances, power tools described herein include a housing and a motor within the housing. The motor may include a rotor and a stator. The rotor may be coupled to a motor shaft to produce a rotational output. The power tool may also include an output drive device configured to be driven by the motor shaft to perform a task. The power tool may also include an actuator configured to be actuated by a user to cause the motor to operate. The power tool may also include a depth sensor located adjacent to the output drive device and configured to generate a distance signal. The power tool may also include a lighting element configured to illuminate a work area of the power tool. The power tool may also include a circuit board located adjacent to the output drive device. The circuit board may include the lighting element and the depth sensor. The power tool may also include a nose piece that surrounds an output axis of the output drive device. The circuit board may be mounted on an inside of a front surface of the nose piece. The nose piece may include a lens to allow light from the lighting element to be emitted through the nose piece to illuminate the work area.

In addition to any combination of features described above, the circuit board may include a ring-like-shaped circuit board that surrounds over half of the output axis of the output drive device.

In addition to any combination of features described above, power tools may include a hammer case held by the housing. The nose piece may cover a front portion of the hammer case. The nose piece may be mounted to the hammer case by being snap fit to a retention ring that is located in a groove on an outer peripheral surface of a forwardly protruding portion of the hammer case. The nose piece may include a rearwardly extending arm that is located between protrusions on the outer peripheral surface of the hammer case to prevent the nose piece from rotating around an output axis of the output drive device.

In addition to any combination of features described above, wires from inside the housing of the power tool that are coupled to the lighting element and the depth sensor may be covered by the rearwardly extending arm.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of various embodiments will become apparent by consideration of the detailed description and accompanying drawings.

### BRIEF DESCRIPTION OF THE DRAWINGS

FIG. 1 illustrates a communication system according to some example embodiments.

FIG. 2 illustrates a power tool of the communication system of FIG. 1 according to some example embodiments.

FIGS. 3A and 3B illustrate a schematic diagram of the power tool of FIG. 2 according to some example embodiments.

FIG. 4 illustrates a flowchart of a method of controlling the power tool of FIG. 2 based at least partially on a distance signal received from a depth sensor of the power tool according to some example embodiments.

FIG. 5 illustrates a flowchart of a method of controlling the power tool of FIG. 2 based at least partially on a distance signal received from a depth sensor of the power tool by determining a feed rate of the power tool according to some example embodiments.

FIG. 6A illustrates a location of the power tool of FIG. 2 relative to a workpiece prior to operation of the power tool to perform a fastening operation according to some example embodiments.

FIG. 6B illustrates a location of the power tool of FIG. 2 relative to the workpiece at the start of a fastening operation according to some example embodiments.

FIG. 6C illustrates a location of the power tool of FIG. 2 relative to the workpiece at the end of a fastening operation according to some example embodiments

FIGS. 7A-7D illustrate a power tool of the communication system of FIG. 1 according to some example embodiments.

### DETAILED DESCRIPTION

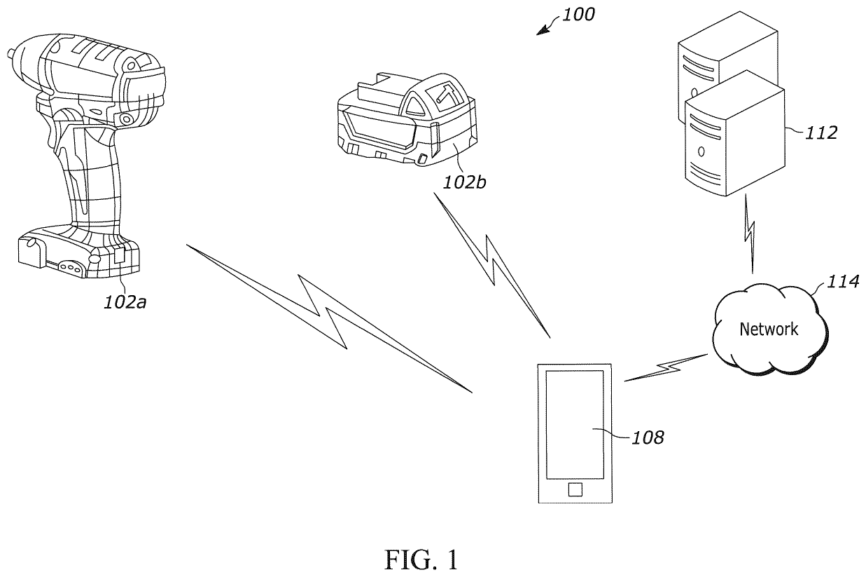

FIG. 1 illustrates a communication system 100. The communication system 100 includes power tool devices 102 and an external device 108. Each power tool device 102 (e.g., battery powered impact driver 102a and power tool battery pack 102b) and the external device 108 can communicate wirelessly while they are within a communication range of each other. Each power tool device 102 may communicate power tool status, power tool operation statistics, power tool identification, stored power tool usage information, power tool maintenance data, and the like. Therefore, using the external device 108, a user can access stored power tool usage or power tool maintenance data. With this tool data, a user can determine how the power tool device 102 has been used, whether maintenance is recommended or has been performed in the past, and identify malfunctioning components or other reasons for certain performance issues. The external device 108 can also transmit data to the power tool device 102 for power tool configuration, firmware updates, or to send commands (e.g., turn on a work light). The external device 108 also allows a user to set operational parameters, safety parameters, select tool modes, and the like for the power tool device 102.

The external device 108 may be, for example, a smart phone (as illustrated), a laptop computer, a tablet computer, a personal digital assistant (PDA), or another electronic device capable of communicating wirelessly with the power tool device 102 and providing a user interface. The external device 108 provides the user interface and allows a user to access and interact with tool information. The external device 108 can receive user inputs to determine operational parameters, enable or disable features, and the like. The user interface of the external device 108 provides an easy-to-use interface for the user to control and customize operation of the power tool.

The external device 108 includes a communication interface that is compatible with a wireless communication interface or module of the power tool device 102. The communication interface of the external device 108 may include a wireless communication controller (e.g., a Bluetooth® module), or a similar component. The external device 108, therefore, grants the user access to data related to the power tool device 102, and provides a user interface such that the user can interact with the controller of the power tool device 102.

In addition, as shown in FIG. 1, the external device 108 can also share the information obtained from the power tool device 102 with a remote server 112 connected by a network 114. The remote server 112 may be used to store the data obtained from the external device 108, provide additional functionality and services to the user, or a combination thereof. In some embodiments, storing the information on the remote server 112 allows a user to access the information from a plurality of different locations. In some embodiments, the remote server 112 may collect information from various users regarding their power tool devices and provide statistics or statistical measures to the user based on information obtained from the different power tools. For example, the remote server 112 may provide statistics regarding the experienced efficiency of the power tool device 102, typical usage of the power tool device 102, and other relevant characteristics and/or measures of the power tool device 102. The network 114 may include various networking elements (routers, hubs, switches, cellular towers, wired connections, wireless connections, etc.) for connecting to, for example, the Internet, a cellular data network, a local network, or a combination thereof. In some embodiments, the power tool device 102 may be configured to communicate directly with the server 112 through an additional wireless interface or with the same wireless interface that the power tool device 102 uses to communicate with the external device 108. In some instances, the communication system 100 may include more of fewer of each of the illustrated devices. For example, the communication system may include more or fewer power tool devices 102 and/or external devices 108.

The power tool device 102 is configured to perform one or more specific tasks (e.g., drilling, cutting, fastening, pressing, lubricant application, sanding, heating, grinding, bending, forming, impacting, polishing, lighting, etc.). For example, an impact wrench and a drill are associated with the task of generating a rotational output (e.g., to drive a bit to drill a hole or secure a fastener to a workpiece).

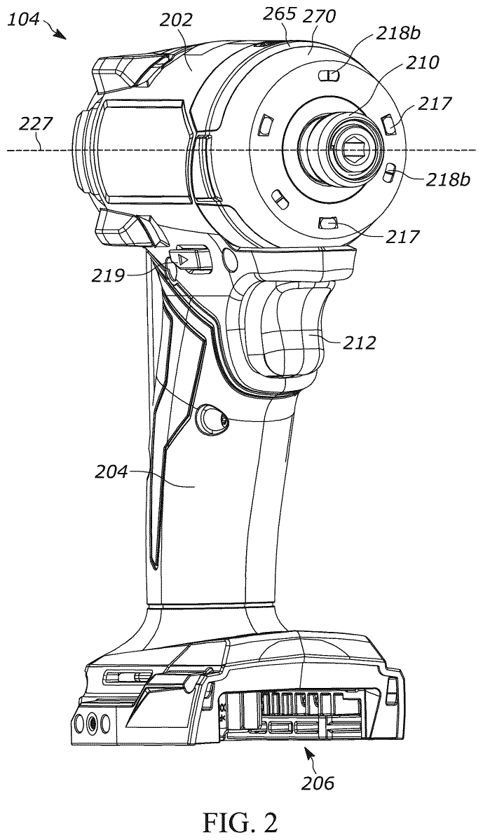

FIG. 2 illustrates an example of the power tool device 102 as an impact driver 104. The impact driver 104 is representative of various types of power tools that operate within the system 100. Accordingly, the description with respect to the impact driver 104 in the system 100 is similarly applicable to other types of power tools, such as other power tools with impact mechanisms (e.g., impact wrenches and impacting angle drivers) or without impact mechanisms (e.g., power drills). As shown in FIG. 2, the impact driver 104 includes an upper main body 202 (e.g., a motor housing), a handle 204, a battery pack receiving portion 206, an output drive device 210, an actuator 212 (e.g., trigger 212), a work light 217 (embodied by multiple work light elements such as light-emitting diodes [LEDs] 217), and forward/reverse selector 219. The housing of the impact driver 104 (e.g., the main body 202, the handle 204, and the battery pack receiving portion 206) are composed of a durable and light-weight plastic material. The output drive device 210 is composed of a metal (e.g., steel). The output drive device 210 on the impact driver 104 is a socket. However, other power tools may have a different drive device 210 specifically designed for the task associated with the other power tool. The battery pack receiving portion 206 is configured to receive and couple to the battery pack (e.g., 102b of FIG. 1) that provides power to the impact driver 104. The battery pack receiving portion 206 includes (i) a connecting structure to engage a mechanism that secures the battery pack and (ii) a terminal block to electrically connect the battery pack to the impact driver 104.

In some instances, the impact driver 104 includes a hammer case 265 located at a front portion of the upper main body 202. The hammer case 265 houses an impact mechanism (not shown) that includes a hammer and an anvil. A nose piece 270 may cover a portion of the front and/or sides of the hammer case 265 to protect the hammer case 265. The nose piece 270 may also house one or more LEDs 217 that serve as a work light for the impact driver 104. For example, most of the nose piece 270 may be opaque but the nose piece 270 may include openings to receive lenses to allow the LEDs 217 to emit light through the lenses to illuminate a work area. The nose piece 270 may also house one or more depth sensors 218b (i.e., distance sensors 218b) located adjacent to the output drive device 210. In some instances, the nose piece 270 may include additional openings to allow the depth sensors 218b to transmit and receive signals (e.g., sound, light, electromagnetic waves, and/or the like) to measure a distance between the depth sensors 218b and a workpiece as described in greater detail below. In some instances, the nose piece 270 does not include the additional openings for the depth sensors 218b. Rather, the depth sensors 218b may be configured to measure a distance between the depth sensors 218b and a workpiece through a front surface of the nose piece 270 while taking the front surface of the nose piece 270 into account.

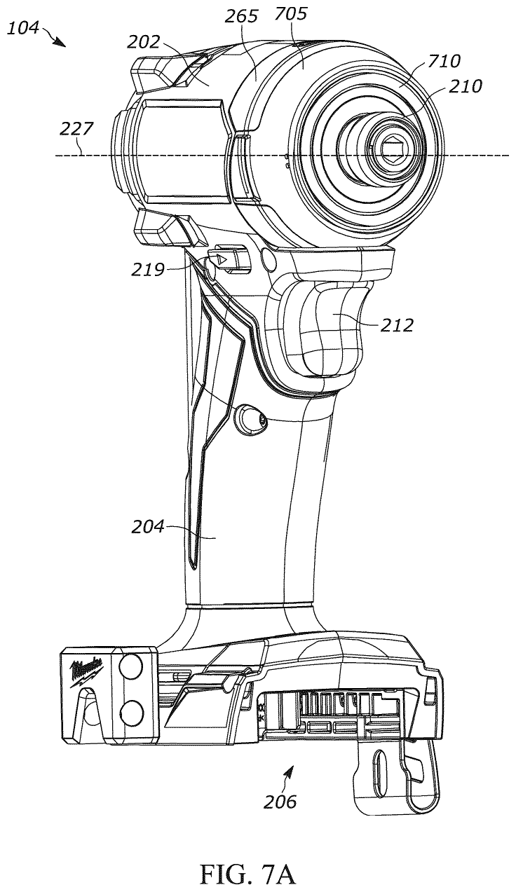

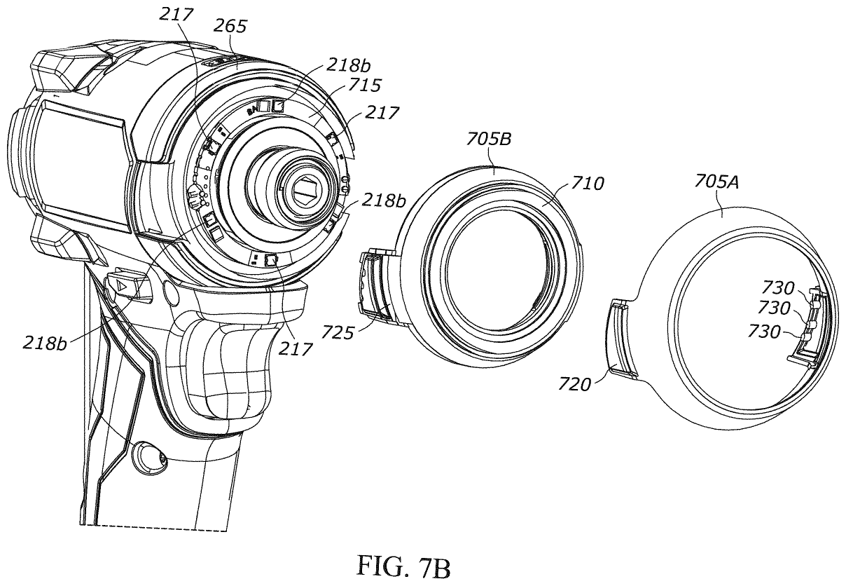

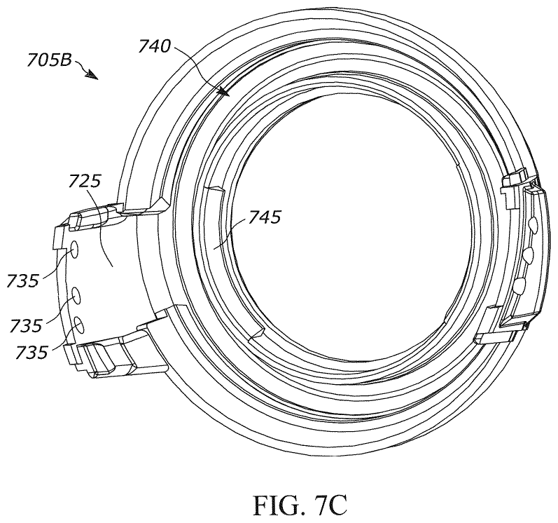

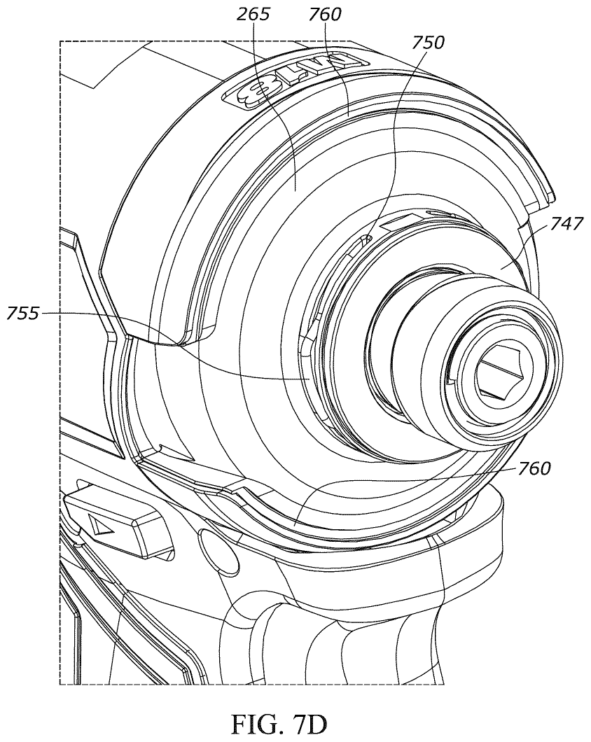

As shown in FIG. 2, in some instances, the impact driver 104 may include three lighting elements 217 (e.g., work light LEDs 217) and three depth sensors 218b. Each depth sensor 218b may be located equidistant from each other spaced approximately 120 degrees apart around an output axis 227 of the output drive device 210. Each depth sensor 218b may be located between two LEDs 217 at an equal distance between each of the two LEDs 217. In some instances, the impact driver 104 may include fewer or additional LEDs 217 and/or depth sensors 218b. In some instances, the impact driver 104 may include LEDs 217 and/or depth sensors 218b in different arrangements. In some instances, the LEDs 217 and depth sensors 218b are located on a ring-shaped or ring-like-shaped circuit board such as a printed circuit board (PCB) that is mounted on the inside of a front surface of the nose piece 270 (see FIGS. 7A-7D). In some instances, three separate arcuate PCBs are mounted on the inside of the front surface of the nose piece 270, and each PCB includes a LED 217 and a depth sensor 218b. In some instances, electrical wires that provide power and/or data signals to/from the LEDs 217 and/or depth sensors 218b may run through an interior of the hammer case 265 back to a main housing of the impact driver 104 to couple to a power source (e.g., a battery pack) and/or to a controller of the impact driver 104. Additionally or alternatively, the electrical wires may run on the outside surface of the hammer case 265 and may be covered by the arms/wings 720, 725 shown in FIG. 7B. In some instances, a portion of the electrical wires may run on the outside surface of the hammer case 265 and another portion of the electrical wires may run through the interior of the hammer case 265.

FIGS. 7A-7D illustrate an example of the impact driver 104 with a different nose piece 705 (i.e., a different work light and depth sensor mounting design). Like-named and like-labeled components may be similar to those described with respect to FIG. 2. The nose piece 705 may also be referred to as a cap, a cover, or a light/sensor holder. As shown in FIG. 7A, the nose piece 705 may include a ring-shaped lens 710. In some instances, the ring-shaped lens 710 may alternatively be a ring-like-shaped lens (e.g., a lens that almost surrounds the output axis 227, for example, by 300 degrees, 330 degrees, by 180 degrees (i.e., over half of the output axis 227 of the output drive device 210), or the like but that does not completely surround the output axis). As shown in the partially exploded view in FIG. 7B, the nose piece 705 may include a transparent light holder 705B that includes the ring-shaped lens 710. The nose piece 705 may also include an opaque overmold 705A (e.g., made of rubber, plastic, or the like). The transparent light holder 705B may include rearwardly extending wings/arms 725 that extend between protrusions on an outer peripheral surface of the hammer case 265. The overmold 705A may include similar rearwardly extending wings/arms 720. Each arm of the overmold 705A may include features 730 (e.g., protrusions 730) configured to engage with corresponding features 735 (e.g., holes/indents 735) (see FIG. 7C) to secure the overmold 705A to the transparent light holder 705B. While the overmold 705A and the transparent light holder 705B are shown as separate components that are mounted to each other, in some instances, the overmold 705A and the transparent light holder 705B are integrally molded together (e.g., using multi-injection molding) to form a unified piece that acts as the light/sensor holder.

The transparent light holder 705B is configured to receive a ring-shaped PCB 715 in a PCB holding groove 740 shown in FIG. 7C. The transparent light holder 705B may include one or more tabs or other mounting features to hold the PCB 715 in place or otherwise properly locate the PCB 715 within the transparent light holder 705B. Additionally or alternatively, epoxy and/or another adhesive may be used to secure the PCB 715 to the transparent light holder 705B. In some instances, the PCB 715 may be ring-like-shaped or may include multiple PCBs distributed around the output axis 227 of the impact driver 104. As shown in FIG. 7B, the ring-shaped PCB 715 may include multiple LEDs 217 and/or depth sensors 218b as described previously herein. Light may be emitted by the LEDs 217 in a ring-like manner through the ring-shaped lens 710 to illuminate a work area in a more shadowless manner compared to light being emitted from individual points on the nose piece 270 shown in FIG. 2. In some instances, the ring-shaped lens 710 may include a light conditioning feature such as a texture and/or a frosting such that light is output in a more uniform manner around the output axis 227.

In some instances, the nose piece 705 is mounted to the hammer case 265 by being snap fit to a retention ring 755 that is located in a groove 750 on an outer peripheral surface of a forwardly protruding portion 747 of the hammer case 265 (see FIG. 7D). The groove 750 and the retention ring 755 may be generally circular in shape but may not form a full 360-degree ring. Rather, as shown in FIG. 7D, the groove 750 and the retention ring 755 may form a circular shape of 350 degrees, 340 degrees, or the like around the output axis 227. The retention ring 755 may include outwardly protruding portions (e.g., at approximately the 3 o'clock position and the 9 o'clock position) that are configured to engage with mounting tabs 745 (see FIG. 7C) of the transparent light holder 705B of the nose piece 705. Accordingly, the retention ring 755 may be inserted into the groove 750, and the nose piece 705 may be pressed onto the front of the hammer case 265 until the mounting tabs 745 snap fit around the protruding portions of the retention ring 755 to secure the nose piece 705 to the hammer case 265 in the front/rear direction. Because the arms 720, 725 of the nose piece 705 are located between protrusions on the outer peripheral surface of the hammer case 265, the nose piece 705 is prevented from rotating around the output axis 227. As shown in FIG. 7D, in some instances, an outer portion of a front surface of the hammer case 265 includes a groove 760 to receive a rear edge of the nose piece 705. The groove 760 may continue onto the outward facing protrusions on the outer peripheral surface of the hammer case 265 to also receive the edges of the arms 720, 725 of the nose piece 705.

Although the power tool device 102 is shown as an impact tool, in some instances, the control methods described herein function on a drill or other power tool that provides a rotational output but that does not include an impact mechanism. Rather, the output drive device 210 of such power tools may be coupled directly to the motor 214 (i.e., direct drive power tools) or may be coupled to the motor 214 via one or more gears (e.g., a gear mechanism). For example, for some power tools 102, the hammer case 265 may instead be a gear case that houses gears instead of an impact mechanism. As another example, some power tools 102 may not include a hammer case 265 or a gear case. Rather, the nose piece 270 may be coupled to a front portion of the upper main body 202 and/or may be formed from/integrated with a front portion of the upper main body 202.

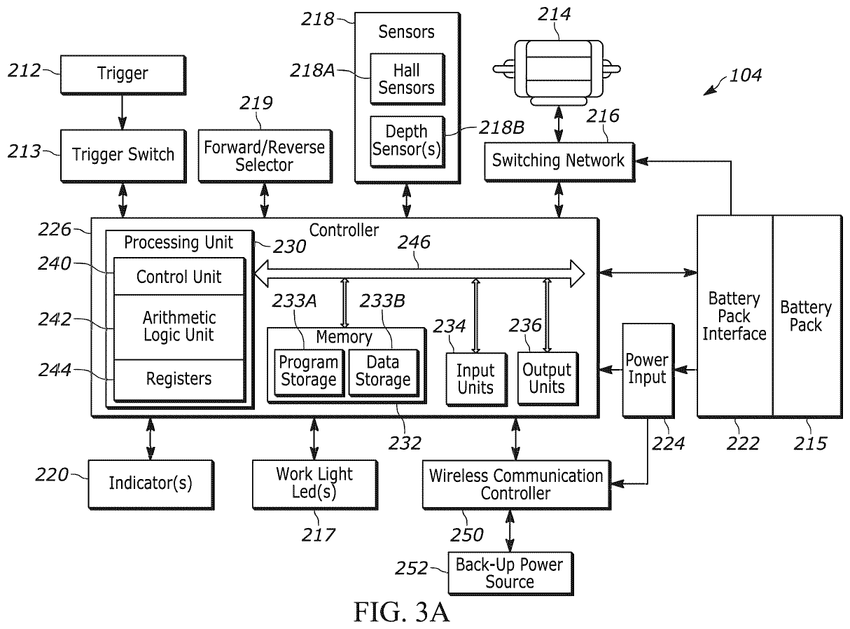

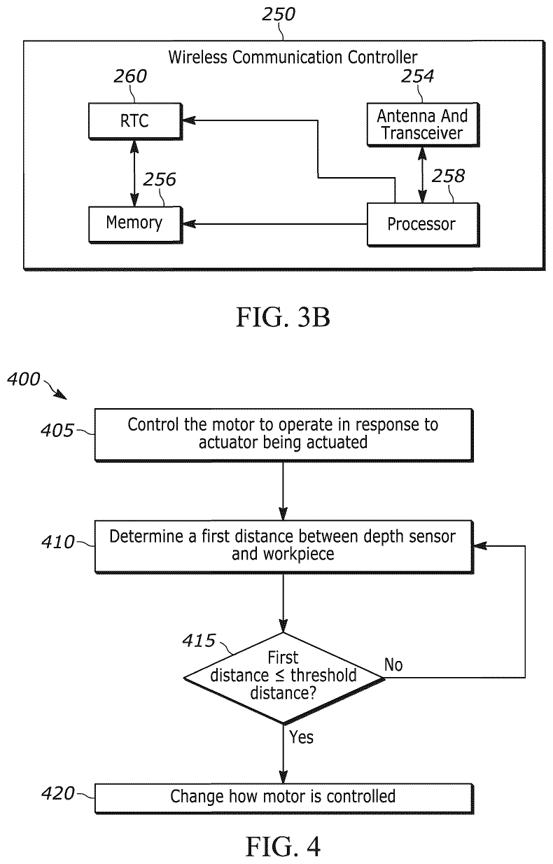

As shown in FIG. 3A, the impact driver 104 also includes a motor 214. The motor 214 actuates the drive device 210 and allows the drive device 210 to perform the particular task (e.g., provide a rotational output to drive a fastener). The motor 214 may include a rotor and a stator. The rotor may be coupled to a motor shaft to produce a rotational output that drives the output drive device 210 directly or via one or more gears. A primary power source (e.g., a battery pack) 215 couples to the impact driver 104 and provides electrical power to energize the motor 214. The motor 214 is energized based on the position of the trigger 212. When the trigger 212 is depressed the motor 214 is energized, and when the trigger 212 is released, the motor 214 is de-energized. In the illustrated embodiment, the trigger 212 extends partially down a length of the handle 204. In other embodiments, the trigger 212 extends down the entire length of the handle 204 or may be positioned elsewhere on the impact driver 104. The trigger 212 is moveably coupled to the handle 204 such that the trigger 212 moves with respect to the tool housing. The trigger 212 is coupled to a push rod, which is engageable with a trigger switch 213 (see FIG. 3A). The trigger 212 moves in a first direction towards the handle 204 when the trigger 212 is depressed by the user. The trigger 212 is biased (e.g., with a spring) such that it moves in a second direction away from the handle 204, when the trigger 212 is released by the user. When the trigger 212 is depressed by the user, the push rod activates the trigger switch 213, and when the trigger 212 is released by the user, the trigger switch 213 is deactivated. In other embodiments, the trigger 212 is coupled to an electrical trigger switch 213. In such embodiments, the trigger switch 213 may include, for example, a transistor. Additionally, for such electronic embodiments, the trigger 212 may not include a push rod to activate the mechanical switch. Rather, the electrical trigger switch 213 may be activated by, for example, a position sensor (e.g., a Hall-Effect sensor) that relays information about the relative position of the trigger 212 to the tool housing or electrical trigger switch 213. The trigger switch 213 outputs a signal indicative of the position of the trigger 212. In some instances, the signal is binary and indicates either that the trigger 212 is depressed or released. In other instances, the signal indicates the position of the trigger 212 with more precision. For example, the trigger switch 213 may output an analog signal that varies from 0 to 5 volts depending on the extent that the trigger 212 is depressed. For example, 0 V output indicates that the trigger 212 is released, 1 V output indicates that the trigger 212 is 20% depressed, 2 V output indicates that the trigger 212 is 40% depressed, 3 V output indicates that the trigger 212 is 60% depressed, 4 V output indicates that the trigger 212 is 80% depressed, and 5 V indicates that the trigger 212 is 100% depressed. The signal output by the trigger switch 213 may be analog or digital.

As also shown in FIG. 3A, the impact driver 104 includes a switching network 216, sensors 218, indicators 220, the battery pack interface 222, a power input unit 224, an electronic controller 226, a wireless communication controller 250, and a back-up power source 252. The back-up power source 252 includes, in some embodiments, a coin cell battery or another similar small replaceable power source. The battery pack interface 222 is coupled to the electronic controller 226 and couples to the battery pack 215. The battery pack interface 222 includes a combination of mechanical (e.g., the battery pack receiving portion 206) and electrical components configured to and operable for interfacing (e.g., mechanically, electrically, and communicatively connecting) the impact driver 104 with the battery pack 215. The battery pack interface 222 is coupled to the power input unit 224. The battery pack interface 222 transmits the power received from the battery pack 215 to the power input unit 224. The power input unit 224 includes active and/or passive components (e.g., voltage step-down controllers, voltage converters, rectifiers, filters, etc.) to regulate or control the power received through the battery pack interface 222 and to the wireless communication controller 250 and controller 226.

The switching network 216 enables the electronic controller 226 to control the operation of the motor 214. Generally, when the trigger 212 is depressed as indicated by an output of the trigger switch 213, electrical current is supplied from the battery pack interface 222 to the motor 214, via the switching network 216. When the trigger 212 is not depressed, electrical current is not supplied from the battery pack interface 222 to the motor 214.

In response to the electronic controller 226 receiving the activation signal from the trigger switch 213, the electronic controller 226 activates the switching network 216 to provide power to the motor 214. The switching network 216 controls the amount of current available to the motor 214 and thereby controls the speed and torque output of the motor 214. The switching network 216 may include numerous FETs, bipolar transistors, or other types of electrical switches. For instance, the switching network 216 may include a six-FET bridge that receives pulse-width modulated (PWM) signals from the electronic controller 226 to drive the motor 214.

The sensors 218 are coupled to the electronic controller 226 and communicate to the electronic controller 226 various signals indicative of different parameters of the impact driver 104 or the motor 214. The sensors 218 include Hall sensors 218a, the depth sensors 218b, among other sensors, such as, for example, one or more voltage sensors, one or more temperature sensors, and one or more torque sensors. Each Hall sensor 218a outputs motor feedback information to the electronic controller 226, such as an indication (e.g., a pulse) when a magnet of the motor's rotor rotates across the face of that Hall sensor 218a. Based on the motor feedback information from the Hall sensors 218a, the electronic controller 226 can determine the position, velocity, and acceleration of the rotor. In response to the motor feedback information and the signals from the trigger switch 213, the electronic controller 226 transmits control signals to control the switching network 216 to drive the motor 214. For instance, by selectively enabling and disabling the FETs of the switching network 216, power received via the battery pack interface 222 is selectively applied to stator coils of the motor 214 to cause rotation of its rotor. The motor feedback information is used by the electronic controller 226 to ensure proper timing of control signals to the switching network 216 and, in some instances, to provide closed-loop feedback to control the speed of the motor 214 to be at a desired level.

In some instances, the depth sensor(s) 218b emit a signal that is reflected off of a workpiece and back to the depth sensor(s) 218b to allow the depth sensor(s) to determine a time of flight of the emitted signal, which is indicative of the distance between the depth sensor(s) 218b and the workpiece. In some instances, the emitted signal may be a sound signal, a light signal, an electromagnetic wave, and/or the like. Based on the time of flight, the depth sensor(s) 218b and/or the electronic controller 226 may determine a distance between the depth sensor(s) 218b and the workpiece. The data provided by the depth sensor(s) 218b to the electronic controller 226 may be referred to as a distance signal. In some instances, other types of depth sensors 218b may be used to determine a distance between the depth sensor(s) 218b and the workpiece and/or other objects.

The indicators 220 are also coupled to the electronic controller 226 and receive control signals from the electronic controller 226 to turn on and off or otherwise convey information based on different states of the impact driver 104. The indicators 220 include, for example, one or more light-emitting diodes (“LED”), or a display screen. The indicators 220 can be configured to display conditions of, or information associated with, the impact driver 104. For example, the indicators 220 are configured to indicate measured electrical characteristics of the impact driver 104, the status of the impact driver 104, the mode of the power tool (discussed below), etc. The indicators 220 may also include elements to convey information to a user through audible or tactile outputs. The work light LEDs 217 are also controllable by the electronic controller 226, for example, to illuminate in response to the trigger 212 being actuated.

As described above, the electronic controller 226 is electrically and/or communicatively connected to a variety of components of the impact driver 104. In some embodiments, the electronic controller 226 includes a plurality of electrical and electronic components that provide power, operational control, and protection to the components within the electronic controller 226 and/or impact driver 104. For example, the electronic controller 226 includes, among other things, a processing unit 230 (e.g., a microprocessor, a microcontroller, an electronic controller, an electronic processor, or another suitable programmable device), a memory 232, input units 234, and output units 236. The processing unit 230 (herein, electronic processor 230) includes, among other things, a control unit 240, an arithmetic logic unit (“ALU”) 242, and a plurality of registers 244 (shown as a group of registers in FIG. 3A). In some embodiments, the electronic controller 226 is implemented partially or entirely on a semiconductor (e.g., a field-programmable gate array [“FPGA”] semiconductor) chip, such as a chip developed through a register transfer level (“RTL”) design process. The electronic controller 226 may include any one or a combination of electronic controllers 226 and/or their components distributed within the impact driver 104. Thus, in the claims, if an apparatus or system is claimed, for example, as including an electronic controller or other element configured in a certain manner, for example, to make multiple determinations, the claim or claim element should be interpreted as meaning one or more electronic controllers (or other element) where any one of the one or more electronic controllers (or other element) is configured as claimed, for example, to make some or all of the multiple determinations. To reiterate, those electronic processors and processing may be distributed within impact driver 104.

The memory 232 is a non-transitory computer readable medium and includes, for example, a program storage area 233a and a data storage area 233b. The program storage area 233a and the data storage area 233b can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The electronic processor 230 is connected to the memory 232 and executes software instructions that are capable of being stored in a RAM of the memory 232 (e.g., during execution), a ROM of the memory 232 (e.g., on a generally permanent basis), or another non-transitory computer readable medium such as another memory or a disc. Software included in the implementation of the impact driver 104 can be stored in the memory 232 of the electronic controller 226. The software includes, for example, firmware, one or more applications, program data, filters, rules, one or more program modules, and other executable instructions. The electronic controller 226 is configured to retrieve from memory and execute, among other things, instructions related to the control processes and methods described herein. The electronic controller 226 is also configured to store power tool information on the memory 232 including operational data, information identifying the type of tool, a unique identifier for the particular tool, and other information relevant to operating or maintaining the impact driver 104. The tool usage information, such as current levels, motor speed, motor acceleration, motor direction, number of impacts, may be captured or inferred from data output by the sensors 218. Such power tool information may then be accessed by a user with the external device 108. In other constructions, the electronic controller 226 includes additional, fewer, or different components.

The wireless communication controller 250 is coupled to the electronic controller 226 or integrated into the electronic controller 226. In the illustrated embodiment, the wireless communication controller 250 is located near the foot of the impact driver 104 (see FIG. 2) to save space and ensure that the magnetic activity of the motor 214 does not affect the wireless communication between the impact driver 104 and the external device 108.

As shown in FIG. 3B, the wireless communication controller 250 includes a radio transceiver and antenna 254, a memory 256, an electronic processor 258, and a real-time clock 260. The radio transceiver and antenna 254 operate together to send and receive wireless messages to and from the external device 108 and the electronic processor 258. The memory 256 can store instructions to be implemented by the electronic processor 258 and/or may store data related to communications between the impact driver 104 and the external device 108 or the like. The electronic processor 258 for the wireless communication controller 250 controls wireless communications between the impact driver 104 and the external device 108. For example, the electronic processor 258 associated with the wireless communication controller 250 buffers incoming and/or outgoing data, communicates with the electronic controller 226, and determines the communication protocol and/or settings to use in wireless communications.

In the illustrated embodiment, the wireless communication controller 250 is a Bluetooth® controller. The Bluetooth® controller communicates with the external device 108 employing the Bluetooth® protocol. Therefore, in the illustrated embodiment, the external device 108 and the impact driver 104 are within a communication range (i.e., in proximity) of each other while they exchange data. In other embodiments, the wireless communication controller 250 communicates using other protocols (e.g., Wi-Fi, cellular protocols, a proprietary protocol, etc.) over a different type of wireless network. For example, the wireless communication controller 250 may be configured to communicate via Wi-Fi through a wide area network such as the Internet or a local area network, or to communicate through a piconet (e.g., using infrared or NFC communications). The communication via the wireless communication controller 250 may be encrypted to protect the data exchanged between the impact driver 104 and the external device 108/network 114 from third parties.

The wireless communication controller 250 is configured to receive data from the power tool electronic controller 226 and relay the information to the external device 108 via the transceiver and antenna 254. In a similar manner, the wireless communication controller 250 is configured to receive information (e.g., configuration and programming information) from the external device 108 via the transceiver and antenna 254 and relay the information to the power tool electronic controller 226.

The RTC 260 increments and keeps time independently of the other power tool components. The RTC 260 receives power from the battery pack 215 when the battery pack 215 is connected to the impact driver 104 and receives power from the back-up power source 252 when the battery pack 215 is not connected to the impact driver 104. Having the RTC 260 as an independently powered clock enables time stamping of operational data (stored in memory 232 for later export) and a security feature whereby a lockout time is set by a user and the tool is locked-out when the time of the RTC 260 exceeds the set lockout time.

The memory 232 stores various identifying information of the impact driver 104 including a unique binary identifier (“UBID”), an ASCII serial number, an ASCII nickname, and a decimal catalog number. The UBID both uniquely identifies the type of tool and provides a unique serial number for each impact driver 104. Additional or alternative techniques for uniquely identifying the impact driver 104 are used in some embodiments.

In some instances, the external device 108 includes some similar components that function in a similar manner as the power tool 102. For example, the external device 108 may include an electronic controller (including one or more electronic processors and one or more memories) and a wireless communication controller to allow the external device 108 to bidirectionally communicate with the power tool 102. In some instances, the external device 108 includes two separate wireless communication controllers, one for communicating with the wireless communication controller 250 of the power tool 102 (e.g., using Bluetooth® or Wi-Fi® communications) and one for communicating through the network 114 (e.g., using Wi-Fi or cellular communications). The external device 108 also may include a touch screen display to output visual data to a user and receive user inputs. The external device 108 may include further user input devices (e.g., buttons, dials, toggle switches, and a microphone for voice control) and further user outputs (e.g., speakers and tactile feedback elements). Additionally, in some instances, the external device 108 has a display without touch screen input capability and receives user input via other input devices, such as buttons, dials, and toggle switches.

In some instances, the server 112 includes some similar components that function in a similar manner as the power tool 102. For example, the server 112 may include an electronic controller (including one or more electronic processors and one or more memories) and a wireless communication controller to allow the server to bidirectionally communicate with the external device 108 and/or the power tool 102.

FIG. 4 illustrates a flowchart of a method 400 of controlling the power tool 102 (e.g., impact driver 104) based at least partially on a distance signal received from a depth sensor 218b. At block 405, the electronic controller 226 controls the motor 214 to operate in response to determining that the actuator 212 has been actuated. For example, the electronic controller 226 may be configured to control the motor 214 to operate at a predetermined speed (e.g., a user-selected speed) regardless of the amount depression of the trigger 212, as long as the trigger 212 is at least partially depressed. In such instances, the speed of the motor 214 does not vary based on the amount of depression of the trigger 212. As another example, the electronic controller 226 may be configured to control the motor 214 to vary the speed of the motor 214 based on the amount of depression of the trigger 212. In some of such instances, the electronic controller 226 may implement a maximum speed value (e.g., a user-selected speed) such that the motor 214 does not exceed the maximum speed value when changing speeds based on the amount of depression of the trigger 212. In other words, full depression of the trigger 212 may result in the motor 214 being operated at the maximum speed value while partial depression of the trigger 212 may result in the motor 214 being operated at a percentage of the maximum speed value that corresponds to the percentage of depression of the trigger 212.

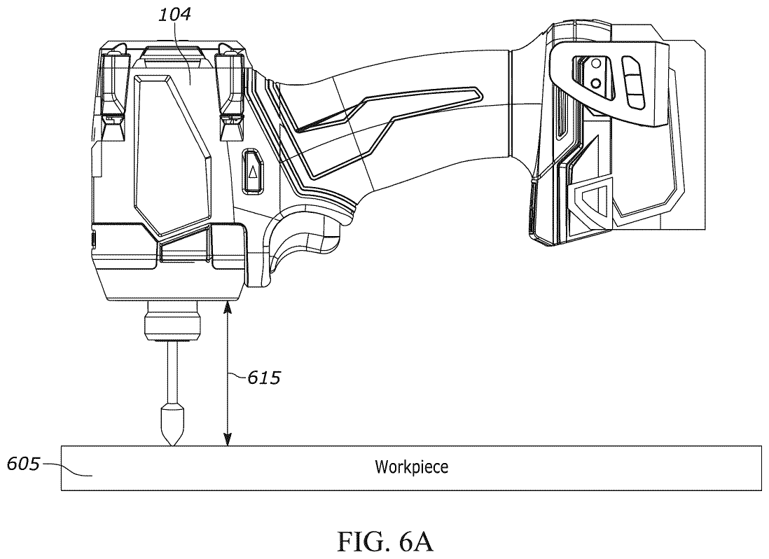

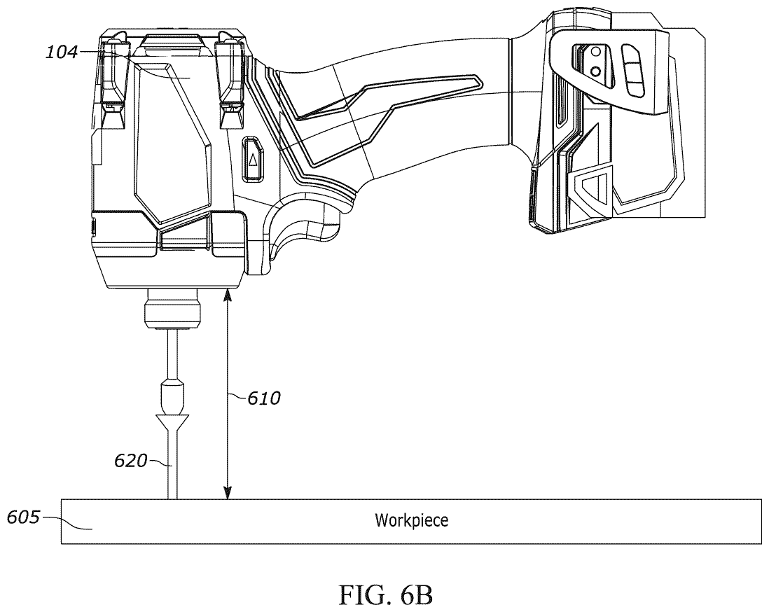

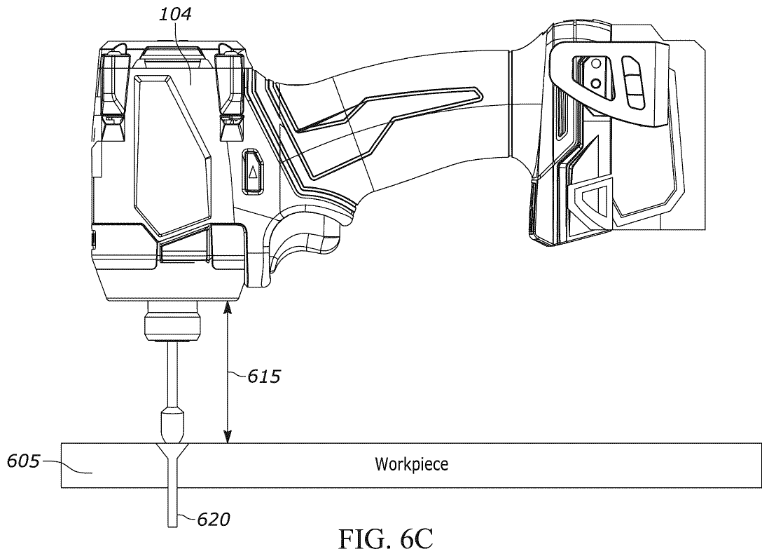

At block 410, the electronic controller 226 determines a first distance 610 (see FIG. 6A) between the depth sensor 218b and a workpiece 605 by monitoring the distance signal from the depth sensor 218b during operation of the motor 214. In some instances, the first distance 610 is greater than a predetermined threshold distance upon the actuator 212 being actuated (e.g., see FIG. 6B that shows the first distance 610 upon the actuator 212 being actuated). For example, the predetermined threshold distance may indicate a desired fastening depth 615 of a fastener 620 (e.g., see FIGS. 6A and 6C) or a depth that is offset from the desired fastening depth 615. The desired fastening depth 615 of the fastener 620 may be set via a user input on the impact driver 104 or the external device 108. In some instances, the desired fastening depth 615 is determined by the electronic controller 226 as a second distance 615 between the depth sensor 218b and the workpiece 605 prior to the motor 214 being activated and in response to a user input that indicates the power tool 102 is located in a position to measure the desired fastening depth 615. For example, as shown in FIG. 6A, the impact driver 104 may be held next to the workpiece 605 in a position that the impact driver 104 would be located upon successfully driving a fastener 620 into the workpiece 605 (i.e., a drill bit attached to the output drive device 210 may be pressed against the workpiece 605 while holding the impact driver 104 approximately perpendicularly to the workpiece 605). When being held in this position, the impact driver 104 and/or the external device 108 may receive a user input that indicates the impact driver 104 is located in a position to measure the desired fastening depth 615. For example, the user input may be a slight depression of the actuator 212 that may be registered by the electronic controller 226 but that may not cause the motor 214 to be activated. Alternatively, the user input may be actuation of a separate button on the impact driver 104 or actuation of a touch key on a touchscreen of the external device 108. As yet another example, the user input may be repeated slight depressions and releases of the actuator 212 (e.g., two or three serial slight depressions and releases of the actuator 212 in a short period of time such as two seconds or the like). In response to receiving the user input, the electronic controller 226 sets the predetermined threshold distance based on the second distance 615 between the depth sensor 218c and the workpiece 605. In situations where the external device 108 receives the user input, the external device 108 may transmit a command to the impact driver 104 to instruct the electronic controller 226 to set the predetermined threshold distance. In some instances, the predetermined threshold distance may correspond exactly to the second distance/desired fastening depth 615. In other instances, the predetermined threshold distance may be offset from the second distance/desired fastening depth 615. The settings for the predetermined threshold distance may be set via user input on the impact driver 104 and/or the external device 108.

At block 415, the electronic controller 226 determines whether the first distance is less than or equal to the predetermined threshold distance (e.g., decreased to be less than or equal to the predetermined threshold distance). A decrease in the first distance may indicate that the fastener 620 is moving into the workpiece 605 during a fastening operation. When the first distance has not decreased to be less than or equal to the predetermined threshold distance (e.g., when the first distance remains greater than the predetermined threshold distance), the method 400 proceeds back to block 410 to continue monitoring the first distance. On the other hand, when the first distance has decreased to be less than or equal to the predetermined threshold distance, the method 400 proceeds to block 420.

At block 420, the electronic controller 226 changes how the motor 214 is controlled to operate in response to determining that the first distance has decreased to be less than or equal to the predetermined threshold distance. In some instances, the electronic controller 226 may decrease the speed of the motor 214, stop the motor 214, or increase the speed of the motor 214 as explained in the non-limiting examples below.

In a first example, the predetermined threshold distance indicates the desired fastening depth 615. At block 420, the electronic controller 226 is configured to change how the motor 214 is controlled to operate in response to determining that the first distance has decreased to be less than or equal to the predetermined threshold distance by stopping the motor 214 (see FIG. 6C). This stopping of the motor 214 may occur even though the actuator 212 remains actuated at the same amount that it was previous actuated. Such stopping of the motor 214 allows the motor 214 to operate to drive the fastener 620 into the workpiece 605 until first distance (i.e., sensed depth) matches the desired fastening depth 615, which increases repeatability of fastening of multiple fasteners 620 of the same type into the workpiece 605. Execution of the method 400 in the manner described in the first example may result in automatically stopping the motor 214 when the fastener 620 is seated. In some instances, after the fastener 620 is seated and the motor 214 has been deactivated, the electronic processor 230 may detect the actuator 212 being depressed and released (e.g., slightly depressed so as not to activate the motor 214 and released) numerous times in a short period of time as explained previously herein. Such repeated actuations of the actuator 212 (i.e., trigger pulls) may indicate that the user desires to adjust the predetermined threshold distance to the current distance being monitored by the depth sensors 218b. Accordingly, in response to detecting repeated trigger pulls (e.g., after the motor 214 has been stopped due to the sensed distance between the power tool 104 and the workpiece being less than or equal to the predetermined threshold distance), the electronic processor 230 may adjust the predetermined threshold distance for future fastening operations to correspond to the current distance measured by the depth sensors 218b. Using this feature, the user may easily slightly adjust or reset/change the predetermined threshold distance.

In a second example, the predetermined threshold distance indicates a second distance away (i.e., offset) from the desired fastening depth 615. For example, the predetermined threshold distance is set (e.g., via user input) to be five millimeters, ten millimeters, two centimeters, or the like shorter than the desired fastening depth 615. At block 420, the electronic controller 226 is configured to change how the motor 214 is controlled to operate in response to determining that the first distance has decreased to be less than or equal to the predetermined threshold distance by slowing a speed of the motor 214 from a first speed (e.g., a driving speed) to a second speed (e.g., a finishing speed). This slowing of the motor 214 may occur even though the actuator 212 remains actuated at the same amount that it was previous actuated. Such slowing of the motor speed allows the motor 214 to operate to more quickly drive the fastener 620 into the workpiece 605 until the first distance (i.e., sensed depth) gets near the desired fastening depth 615, at which point the motor speed is slowed to give the user more precise control of when to stop driving the fastener 620 as the fastener 620 becomes seated within the workpiece 605. Execution of the method 400 in the manner described in the second example may result in automatically slowing down the motor 214 when the fastener 620 is nearly seated.

In a third example, block 420 is executed near the beginning of a fastening operation instead of near or at the end of a fastening operation. In this example, the electronic controller 226 is configured to determine an initial distance 610 between the depth sensor 218b and the workpiece 605 at a time that the actuator 212 is actuated and in response to determining that the actuator 212 has been actuated (see FIG. 6B). The electronic controller 226 is then configured to determine the predetermined threshold distance by subtracting a predetermined value from the initial distance 610 (e.g., one centimeter, two centimeters, or the like). Accordingly, the first distance decreasing to be less than or equal to the predetermined threshold distance may indicate that the fastener 620 has at least partially entered the workpiece 605 far enough to prevent bit/screw walking where the fastener 620 can slide out of the workpiece 605 along a surface of the workpiece 605. At block 420, the electronic controller 226 is configured to change how the motor 214 is controlled to operate in response to determining that the first distance has decreased to be less than or equal to the predetermined threshold distance by increasing a speed of the motor 214 from a starting speed to a driving speed. This increasing of the motor speed may occur even though the actuator 212 remains actuated at the same amount that it was previous actuated. Such increasing of the motor speed allows the motor 214 to operate more slowly at the beginning of a fastening operation to allow the user to ensure that the fastener 620 is adequately partially inserted into the workpiece 605 to prevent bit/screw walking while allowing for increased driving speeds once the fastener 620 is adequately partially inserted into the workpiece 605. Execution of the method 400 in the manner described in the third example may be referred to as automatic speed ramp-up.

As indicated previously herein, the motor speeds referred to in this disclosure (e.g., the motor speeds mentioned in the above-noted examples) may be non-varying based on the amount of actuation of the actuator 212 or may be varying based on the amount of actuation of the actuator 212. Accordingly, the motor speeds described herein (e.g., the motor speeds that change in the above-noted examples) may be a speed value of a motor speed that does not vary based on the amount of actuation of the actuator 212 and/or may be a maximum speed value of a range of motor speeds that vary based on the amount of actuation of the actuator 212.

While the first, second, and third examples are described separately above, in some instances, any two or all three of the control methods explained in the examples may be implemented during a single fastening operation.

The parameters (e.g., motor speed(s) such as starting speed, driving speed, and finishing speed; distance(s) such as the desired fastening depth 615 and an offset distance from the desired fastening depth 615, and/or the like) used or set by the electronic controller 226 during execution of the method 400 may be entered via user input on the power tool 102 and/or on the external device 108. For example, a distance may be entered via user input or a length of a bit may be entered via user input and converted to a distance measurement based on known dimensions of the power tool 102. Some of the parameters may be set to default values at the time of manufacturing of the power tool 102. In some instances, the power tool 102a is set to perform a manual fastening operation that will be controlled by the user and that will be monitored by the electronic controller 226 to determine (i.e., learn) the desired fastening depth 615 and/or other parameters to be saved for future fastening operations. For example, the electronic controller 226 is configured to determine the predetermined threshold distance by monitoring the distance signal from the depth sensor 218b during driving of a previous fastener 620 into the workpiece 605 by (i) determining a second distance between the depth sensor 218b and the workpiece 605 in response to the motor 214 being deactivated upon completion of a fastening operation of the previous fastener, and (ii) setting the predetermined threshold distance based on the second distance. As indicated in the first and second examples above, the predetermined threshold distance may be set to be the desired fastening depth 615 (for stopping the motor 214 when the fastener 620 is seated) or a value offset from the desired fastening depth 615 (for slowing down the motor 214 when the fastener 620 is nearly seated).

In some instances, the electronic controller 226 and/or the external device 108 may set one or more parameters using values generated by a machine learning algorithm. For example, the machine learning algorithm may be generated by a power tool manufacturer by performing numerous manual fastening operations (e.g., in a testing environment) using the power tool 102 that are each monitored by an electronic controller using sensors (e.g., the electronic controller 226 using sensors 218 of the power tool 102, an electronic controller and sensors on testing equipment, and/or the like). The manufacturer may also keep track of a respective success rating (e.g., on a scale from one to ten) for each fastening operation, for example, by providing a user input to testing equipment or to the power tool 102 and/or external device 108. Based on the monitored parameters and the success rating of each fastening operation, the power tool 102, external device 108, and/or the testing equipment may determine one or more parameters to use during future similar fastening operations (e.g., changing motor speeds at different depths and/or the like). For example, the monitored parameters and the success ratings may be used to train a neural network to generate power tool parameters that are saved on the memory 232 of the power tool 102 for use in future similar situations (e.g., based on a desired fastening depth 615, a type of fastener 620, and/or a type of workpiece 605). In some instances, after manufacturing and during use by a user, the power tool 102 and/or the external device 108 may receive further feedback via user input (e.g., a success rating of a fastening operation using the machine learning parameters) to allow the electronic controller 226 and/or the external device 108 to further refine the machine learned parameters that may have been set during manufacturing and/or to further refine the machine learned parameters programmed by the manufacturer on future similar power tools.

The indicators 220 and/or another user interface (e.g., a display screen) of the power tool 102 may indicate how the power tool 102 is currently configured to operate (e.g., automatic stopping of the motor 214, automatic slowdown of the motor 214, automatic ramp-up of motor speed, and/or the like). Via user input on the power tool 102 and/or the external device 108, the user may be able to enable or disable each feature and/or reset/reconfigure each feature to operate according to different values.

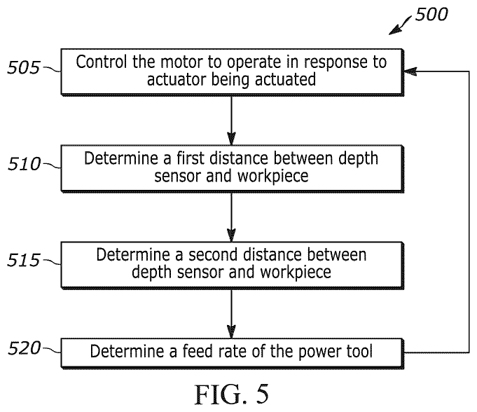

FIG. 5 illustrates a flowchart of another method 500 of controlling the power tool 102 (e.g., impact driver 104) based at least partially on a distance signal received from a depth sensor 218b by determining a feed rate of the power tool 102. At block 505, the electronic controller 226 controls the motor 214 to operate in response to determining that the actuator 212 has been actuated. In some instances, block 505 is similar to block 405 of FIG. 4 described previously herein.

At block 510, the electronic controller 226 determines a first distance between the depth sensor 218b and the workpiece 605 by monitoring the distance signal from the depth sensor 218b during operation of the motor 214 at a first time. For example, the first distance may be determined in response to actuation of the actuator 212, at a time just after actuation of the actuator 212, and/or at a time in the first 25%, 50%, 75%, 95%, or the like of a fastening operation.

At block 515, the electronic controller 226 determines a second distance between the depth sensor 218b and the workpiece 605 by monitoring the distance signal from the depth sensor 218b during operation of the motor 214 at a second time. The second time may be after the first time (e.g., 0.1, 0.5, one, or the like seconds after the first time).

At block 520, the electronic controller 226 determines a feed rate of the power tool 102 based on (i) a first difference between the first distance and the second distance and (ii) a second difference between the first time and the second time. For example, the electronic controller 226 may divide the first difference by the second difference to determine the feed rate. In some instances, the feed rate indicates a depth that the power tool 102 (and accordingly, the fastener 620) has traveled axially along the output axis 227 of the power tool 102 toward the workpiece 605 over a period of time.

In some instances, the electronic controller 226 is configured to implement a motor speed control loop to control a speed of the motor 214 based on the feed rate to maintain the feed rate within a range of a predetermined feed rate value. This predetermined feed rate value may be set and/or adjusted in any one of the manners described above with respect to other parameters of the power tool 102 (e.g., set via user input on the power tool 102 and/or the external device 108). In some instances, the power tool 102 and/or the external device 108 may also receive a user input that indicates what type of power tool operation (e.g., fastening operation) is being performed to allow the power tool 102 to automatically select a desired feed rate based on the power tool operation (e.g., using a look-up table). For example, a desired feed rate for fastening a large diameter screw into wood may be different than a desired feed rate for fastening a small diameter screw into drywall.

In some instances, the electronic controller 226 is configured to use the feed rate to determine a fastener pitch (e.g., a screw pitch) of a fastener 620 being fastened into the workpiece 605. For example, the electronic controller is configured to determine a speed of the motor (i) by monitoring a position signal from a position sensor 218a associated with the motor 214, (ii) determine an output speed of the output drive device 210 based on the speed of the motor 214, and (iii) determine a fastener pitch of a fastener 620 being fastened by the power tool 102 based on the feed rate and the output speed. In some instances, the fastener pitch is determined by dividing the feed rate by the output speed. In some instances, the output speed is determined by dividing the speed of the motor 214 by a gear ratio(s) of a gear mechanism(s) between the motor 214 and the output drive device 210. For example, direct drive power tools do not include any gears and, thus, the motor speed corresponds directly to the output speed. However, many power tools include gears coupled between the motor 214 and the output drive device 210 that reduce the output speed relative to the motor speed. In some instances, the fastener pitch determination is only performed when a power tool 102 has its motor speed correlate with output speed. In other words, in some instances, the fastener pitch determination is only performed on non-impact power tools or when impact tools are not impacting since motor speed is not necessarily correlated to output speed when an impact tool is impacting. In some instances, once the fastener pitch is determined for a given operation/fastener (e.g., at the beginning of a fastening operation), the electronic controller 226 may utilize the fastener pitch to set one or more parameters of operation of the power tool 102. For example, based on a look-up table or based on stored parameters from machine learning performed during manufacturing that are related to a specific screw pitch value, the electronic controller 226 may control the feed rate to be maintained within a certain range as explained previously herein. As another example, the electronic controller 226 may change how the motor 214 is controlled (at block 420) in different manners depending on a screw pitch of a fastener that was determined at the beginning of a fastening operation. In some instances, screw pitch information may be logged by the power tool 102 and/or the external device 108 for future analysis by a power tool manufacturer to determine the types of applications being performed using the power tool 102 and/or to adjust machine learning algorithms used to program future similar power tools.

In some instances, the electronic controller 226 implements a fastener stripping prevention method by slowing down or stopping the motor 214 in response to determining that the speed of the motor 214 has increased while the feed rate has decreased. For example, the electronic controller 226 is configured to (i) determine a speed of the motor 214 by monitoring a position signal from a position sensor 218a associated with the motor 214, (ii) determine that the speed of the motor 214 has increased a first predetermined amount, and (iii) determine that the feed rate has decreased a second predetermined amount. The electronic controller 226 may also be configured to (iv) change how the motor 214 is controlled to operate by stopping the motor 214 or by slowing a speed of the motor 214 from a first speed to a second speed in response to determining (i) that the speed of the motor 214 has increased the first predetermined amount and (ii) that the feed rate has decreased the second predetermined amount. In some instances, the first predetermined amount and the second predetermined amount may be percentages of their respective parameters. The first predetermined amount and the second predetermined amount may be the same or different percentages. In other instances, the first predetermined amount may be a rotational speed value (e.g., revolution per minute [RPM]) and the second predetermined amount may be a translational speed value (e.g., depth over time). The parameter values for the fastener stripping prevention method (e.g., speed values, increase amount, decrease amount, etc.) may be set and/or adjusted in any one of the manners described above with respect to other parameters of the power tool 102. Similar to the fastener pitch determination described above, in some instances, the fastener stripping prevention method may only be performed on non-impact power tools (e.g., on direct drive power tools) or when impact tools are not impacting.

In some instances, one or more of the control methods explained in the examples with respect to FIG. 4 may be implemented in combination with one or more of the control methods explained with respect to FIG. 5 during a single fastening operation.

While the above-noted implementations of the methods 400 and 500 refer to “a depth sensor 218b,” it should be understood that depth measurements may be taken by one or more depth sensors 218b. In instances where the power tool 102 includes multiple depth sensors 218b, an average value of the multiple depth sensors 218b may be determined by the electronic controller 226 as the current distance between the power tool 102 and the workpiece 605. In other instances, the electronic controller 226 may use a shortest distance from any one of the depth sensors 218b as the current distance between the power tool 102 and the workpiece 605.

Turning to additional and/or alternative uses of the depth sensors 218b of the power tool 102, distance signals from multiple depth sensors 218b (e.g., at least three depth sensors 218b located equidistant around the output axis 227 of the power tool 102) may be used by the electronic controller 226 to determine whether the power tool 102 is being held perpendicularly to the workpiece 605. For example, if the distance signals from all of the depth sensors 218b indicate a distance/depth within a predetermined percentage from each other (e.g., 5%, 10%, 15%, or the like), then the electronic controller 226 may determine that the power tool 102 is sufficiently perpendicular to the workpiece 605. On the other hand, if a distance signal from one or more of the depth sensors 218b is different than a distance signal from one or more other depth sensors 218b by more than the predetermined percentage, then the electronic controller 226 may determine that the power tool 102 is not sufficiently perpendicular to the workpiece 605. In some instances, the indicators 220 and/or another user interface of the power tool 102 may indicate whether the power tool is sufficiently perpendicular to the workpiece 605. In some instances, the indicators 220 and/or another user interface of the power tool 102 may indicate a direction to move or rotate the power tool 102 to achieve sufficient perpendicularity.

In some instances, the indicators 220 and/or another user interface of the power tool 102 may indicate a distance from a depth sensor 218b (e.g., from a front face of the power tool 102) to a surface toward which the power tool 102 is pointed. In other words, the power tool 102 may use one or more depth sensors 218b to act as a digital tape measure.

In some instances, the depth sensors 218b may include multi-zone time-of-flight sensors that may be used to identify and measure workpiece edges using information from the zones that aligns with the edges of the workpiece and/or calculate areas of interest. The depth sensors 218b may allow for complex two-dimensional (2D) and three-dimensional (3D) measurements of the workpiece. Using this information, the electronic controller 226 may determine whether the zones are measuring any distance outside of the workpiece measurements. The electronic controller 226 may assess such distances and decide to keep the measured distance (e.g., a presumed accurate distance) or discard the measured distance (e.g., a presumed inaccurate distance). Additionally, wall tracking capabilities may be leveraged by the electronic controller 226 in order to discard distance readings that fall outside the wall being tracked. Furthermore, workpiece edges within each zone can be selected by the electronic controller 226 and may be used to identify a height of the workpiece (e.g., if an application is being performed around the edge of a workpiece 605). As indicated by the above-noted examples, the depth sensors 218b may aid the user in completing work effectively. For example, the distance measurements and determinations explained in the above examples may improve performance during corner use cases (i.e., determine and/or output accurate distance when the power tool 102 is being used in a corner such as a corner of a room or a corner of a workpiece with intersecting portions in numerous planes).

In some instances, depth sensors 218b with multiple zones may be used to position or augment other positioning systems of the power tool 102 (e.g., an inertial measurement unit (IMU), a camera, short-range wireless communication (e.g., Bluetooth™), etc. to determine a position of the power tool 102 in 3D space (e.g., at a given worksite).

In some instances, depth sensors 218b with multiple zones may be used for obstacle detection and/or gesture recognition. Based on data from the depth sensors 218b, the electronic processor 230 may identify entry of an obstacle that is not the target workpiece (e.g., a user's hand) into a field of view of the depth sensors 218b. In response thereto, the electronic processor 230 may provide an alert to the user (e.g., flashing a LED, or the like) and/or may perform object detection and/or gesture recognition. For example, the electronic processor 230 may determine a user's hand is at least partially blocking the field of view of the depth sensors 218b and may provide an alert to indicate that the depth sensors 218b are at least partially blocked. In some instances, the electronic processor 230 may additionally or alternatively cease operation of the motor 214. In response to determining that the user's hand has been removed and that the depth sensors 218b are no longer blocked, the electronic processor 230 may disable the alert and/or continue normal operation of the motor 214.

In some instances, the power tool 102 may include an electronic clutch (E-clutch) feature that stops the motor 214, for example, in response to the torque of the output drive device 210 exceeding a predetermined torque threshold. In some instances, the torque of the output drive device 210 may be estimated based at least in part on a current signal from a current sensor that monitors motor current. In some instances, the power tool 102 may include an enhanced E-clutch feature that restarts the motor 214 in response to the actuator 212 remaining actuated after the E-clutch feature stopped the motor 214. In some instances, functionality similar to the enhanced E-clutch feature may be combined with the depth sensing by the depth sensors 218b to control the power tool 102 in certain manners. In other words, the enhanced E-clutch feature allows the E-clutch to be activated to stop the motor 214 at certain depth intervals during a fastening operation in addition to or as an alternative to stopping the motor 214 based on the torque of the output drive device 210 exceeding the predetermined torque threshold. In some instances, the electronic controller 226 may be configured to operate the motor 214 in a pulsed manner for a specified depth change for each pulse. For example, in response to the actuator 212 being actuated, the motor 214 may be enabled until a measured depth decreases a predetermined depth amount from an initial depth at which point the motor 214 is disabled for a predetermined period of time (e.g., 0.5 seconds, 1 second, or the like). As long as the actuator 212 remains actuated during this predetermined period of time, once the predetermined period of time elapses, the motor 214 may be re-enabled at the end of the predetermined period of time until the measured depth again decreases the predetermined depth amount from its value when the motor 214 was restarted. This pulsing on/off of the motor 214 using the E-clutch (e.g., enabling and disabling the motor 214 while the actuator 212 remains actuated) may repeat until the measured depth reaches a desired fastening depth 615 or until the actuator 212 is released. In other words, the electronic controller 226 may continue, until a measured depth/distance reaches a desired fastening depth or until the actuator 212 is released, operating the motor 214 in the pulsed manner by disabling the motor 214 for the predetermined period of time and enabling the motor 214 after the predetermined period of time and until a measured distance has again decreased the specified depth change from a depth measured during the predetermined period of time of a directly preceding instance of the motor 214 being disabled. Such pulsing on/off of the motor 214 may allow the electronic controller 226 to limit the feed rate of the power tool 102 during a fastening operation by periodically and briefly disabling the motor 214 during the fastening operation. In some instances, such pulsing on/off of the motor 214 may also be used to allow the electronic controller 226 to control the power tool 102 to perform a fastening operation at a desired/specified feed rate.

Thus, embodiments described herein provide, among other things, systems and methods for controlling power tools that include one or more depth sensors. Various features and advantages of the invention are set forth in the following claims.

We claim:

1. A power tool comprising:
a housing;
a motor within the housing, wherein the motor includes a rotor and a stator, wherein the rotor is coupled to a motor shaft to produce a rotational output;
an output drive device configured to be driven by the motor shaft to perform a task;
an actuator configured to be actuated by a user to cause the motor to operate;
a depth sensor located adjacent to the output drive device and configured to generate a distance signal; and
an electronic controller including an electronic processor and a memory, the electronic controller coupled to the actuator and to the depth sensor, the electronic controller configured to:
control the motor to operate in response to determining that the actuator has been actuated,
determine a first distance between the depth sensor and a workpiece by monitoring the distance signal from the depth sensor during operation of the motor, wherein the first distance is greater than a predetermined threshold distance upon the actuator being actuated,
determine that the first distance has decreased to be less than or equal to the predetermined threshold distance, and
change how the motor is controlled to operate in response to determining that the first distance has decreased to be less than or equal to the predetermined threshold distance.

2. The power tool of claim 1, wherein the predetermined threshold distance indicates a desired fastening depth; and
wherein the electronic controller is configured to change how the motor is controlled to operate in response to determining that the first distance has decreased to be less than or equal to the predetermined threshold distance by stopping the motor.

3. The power tool of claim 1, wherein the predetermined threshold distance indicates a second distance away from a desired fastening depth; and
wherein the electronic controller is configured to change how the motor is controlled to operate in response to determining that the first distance has decreased to be less than or equal to the predetermined threshold distance by slowing a speed of the motor from a first speed to a second speed.

4. The power tool of claim 1, wherein, to determine the predetermined threshold distance by monitoring the distance signal from the depth sensor during driving of a previous fastener into the workpiece, the electronic controller is configured to:
determine a second distance between the depth sensor and the workpiece in response to the motor being deactivated upon completion of a fastening operation of the previous fastener; and
set the predetermined threshold distance based on the second distance.

5. The power tool of claim 1, wherein the electronic controller is configured to determine the predetermined threshold distance by determining a second distance between the depth sensor and the workpiece prior to the motor being activated and in response to a user input that indicates the power tool is located in a position to measure a desired fastening depth; and
wherein the electronic controller is configured to set the predetermined threshold distance based on the second distance.

6. The power tool of claim 1, wherein the electronic controller is configured to:
determine an initial distance between the depth sensor and the workpiece at a time that the actuator is actuated and in response to determining that the actuator has been actuated; and
determine the predetermined threshold distance by subtracting a predetermined value from the initial distance;
wherein the electronic controller is configured to change how the motor is controlled to operate in response to determining that the first distance has decreased to be less than or equal to the predetermined threshold distance by increasing a speed of the motor from a starting speed to a driving speed.

7. The power tool of claim 1, wherein the predetermined threshold distance indicates a specified depth change from an initial depth; and
wherein the electronic controller is configured to operate the motor in a pulsed manner by:
disabling the motor for a predetermined period of time in response to determining that the first distance has decreased the specified depth change from the initial depth to a second depth,
determining that the actuator has remained actuated during the predetermined period of time,
in response to determining that the predetermined period of time has elapsed and that the actuator has remained actuated during the predetermined period of time, re-enabling the motor until the first distance has again decreased the specified depth change from the second depth,
disabling the motor for the predetermined period of time in response to determining that the first distance has again decreased the specified depth change from the second depth, and
continuing, until the first distance reaches a desired fastening depth or until the actuator is released, operating the motor in the pulsed manner by disabling the motor for the predetermined period of time and enabling the motor after the predetermined period of time and until the first distance has again decreased the specified depth change from a depth measured during the predetermined period of time of a directly preceding instance of the motor being disabled.

8. The power tool of claim 1, further comprising:
a lighting element configured to illuminate a work area of the power tool; and
a circuit board located adjacent to the output drive device, wherein the circuit board includes the lighting element and the depth sensor.

9. The power tool of claim 8, wherein the circuit board includes a ring-like-shaped circuit board that surrounds over half of an output axis of the output drive device.

10. The power tool of claim 8, further comprising:
a hammer case held by the housing; and
a nose piece that covers a front portion of the hammer case;
wherein the circuit board is mounted on an inside of a front surface of the nose piece;
wherein the nose piece includes a lens to allow light from the lighting element to be emitted through the nose piece to illuminate the work area.

11. The power tool of claim 10, wherein the nose piece is mounted to the hammer case by being snap fit to a retention ring that is located in a groove on an outer peripheral surface of a forwardly protruding portion of the hammer case; and
wherein the nose piece includes a rearwardly extending arm that is located between protrusions on the outer peripheral surface of the hammer case to prevent the nose piece from rotating around an output axis of the output drive device.

12. A power tool comprising:
a housing;
a motor within the housing, wherein the motor includes a rotor and a stator, wherein the rotor is coupled to a motor shaft to produce a rotational output;
an output drive device configured to be driven by the motor shaft to perform a task;
an actuator configured to be actuated by a user to cause the motor to operate;
a depth sensor located adjacent to the output drive device and configured to generate a distance signal; and
an electronic controller including an electronic processor and a memory, the electronic controller coupled to the actuator and to the depth sensor and configured to:
control the motor to operate in response to determining that the actuator has been actuated,
determine a first distance between the depth sensor and a workpiece by monitoring the distance signal from the depth sensor during operation of the motor at a first time,
determine a second distance between the depth sensor and the workpiece by monitoring the distance signal from the depth sensor during operation of the motor at a second time, and
determine a feed rate of the power tool based on (i) a first difference between the first distance and the second distance and (ii) a second difference between the first time and the second time.

13. The power tool of claim 12, wherein the electronic controller is configured to control a speed of the motor based on the feed rate to maintain the feed rate within a range of a predetermined feed rate values.

14. The power tool of claim 12, wherein the electronic controller is configured to:
determine a speed of the motor by monitoring a position signal from a position sensor associated with the motor;
determine an output speed of the output drive device based on the speed of the motor; and
determine a fastener pitch of a fastener being fastened by the power tool based on the feed rate and the output speed.

15. The power tool of claim 14, wherein the electronic controller is configured to control, based on the fastener pitch, the feed rate to be maintained within a range of a predetermined feed rate values.

16. The power tool of claim 12, wherein the electronic controller is configured to:
determine a speed of the motor by monitoring a position signal from a position sensor associated with the motor;
determine that the speed of the motor has increased a first predetermined amount;
determine that the feed rate has decreased a second predetermined amount; and
change how the motor is controlled to operate by stopping the motor or by slowing a speed of the motor from a first speed to a second speed in response to determining (i) that the speed of the motor has increased the first predetermined amount and (ii) that the feed rate has decreased the second predetermined amount.

17. A power tool comprising:
a housing;
a motor within the housing, wherein the motor includes a rotor and a stator, wherein the rotor is coupled to a motor shaft to produce a rotational output;
an output drive device configured to be driven by the motor shaft to perform a task;
an actuator configured to be actuated by a user to cause the motor to operate;
a depth sensor located adjacent to the output drive device and configured to generate a distance signal;
a lighting element configured to illuminate a work area of the power tool;
a circuit board located adjacent to the output drive device, wherein the circuit board includes the lighting element and the depth sensor; and
a nose piece that surrounds an output axis of the output drive device;
wherein the circuit board is mounted on an inside of a front surface of the nose piece, and
wherein the nose piece includes a lens to allow light from the lighting element to be emitted through the nose piece to illuminate the work area.

18. The power tool of claim 17, wherein the circuit board includes a ring-like-shaped circuit board that surrounds over half of the output axis of the output drive device.

19. The power tool of claim 17, further comprising:
a hammer case held by the housing;
wherein the nose piece covers a front portion of the hammer case;
wherein the nose piece is mounted to the hammer case by being snap fit to a retention ring that is located in a groove on an outer peripheral surface of a forwardly protruding portion of the hammer case; and
wherein the nose piece includes a rearwardly extending arm that is located between protrusions on the outer peripheral surface of the hammer case to prevent the nose piece from rotating around an output axis of the output drive device.

20. The power tool of claim 19, wherein wires from inside the housing of the power tool that are coupled to the lighting element and the depth sensor are covered by the rearwardly extending arm.
